(19) United States
(12) Patent Application Publication
(10) Pub. No.: US 2003/0224678 A1
(43) Pub. Date: Dec. 4, 2003

(54) Web pad design for chemical mechanical polishing

(75) Inventors: Wei-Yung Hsu, Santa Clara, CA (US); Yutao Ma, Fremont, CA (US); Sen-Hou Ko, Sunnyvale, CA (US); Daniel A. Carl, Pleasanton, CA (US)

Correspondence Address: Patent Counsel, Applied Materials, Inc., P.O. Box 450-A, Santa Clara, CA, 95052, US

(73) Assignee: APPLIED MATERIALS, INC.

(21) Appl. No.: 10/159,183

(22) Filed: May 31, 2002

(51) Int. Cl. D04B 1/00; D04C 1/00; D04G 1/00; D03D 9/00; D03D 19/00; D04B 21/00; D04H 1/00; B32B 5/02; B32B 27/04; B32B 27/12; D03D 15/00; B32B 27/02

(52) U.S. Cl. 442/43; 442/1; 442/2; 442/45; 442/49; 442/149; 442/164; 442/35

(57) ABSTRACT

An article and method are provided for polishing a substrate surface. In one aspect, the invention provides polishing articles including a linear strip of backing material and a fibrous polishing material disposed on the backing material. The polishing material may be in the form of individual fibers, a mesh of fibers, a web of fibers, an interwoven cloth of fibers, or felt. The polishing material may be impregnated or coated with a polishing enhancing material. The polishing article may be disposed in an apparatus for processing a substrate on a platen. In operation, a substrate is contacted with the polishing article and relative motion is provided between the substrate and the polishing article to remove material from the substrate surface.

### BACKGROUND OF THE INVENTION

1. Field of the Invention

The invention relates generally to apparatus and methods for the fabrication of semiconductor devices and polishing and planarizing substrates.

2. Description of the Related Art

Chemical mechanical planarization, or chemical mechanical polishing (CMP), is a common technique used to planarize substrates. In conventional CMP techniques, a substrate carrier or polishing head is mounted on a carrier assembly and positioned in contact with a polishing material in a CMP apparatus. The carrier assembly provides a controllable pressure to the substrate urging the substrate against the polishing material. The substrate and polishing material are moved in a relative motion to one another.

A polishing composition is provided to the polishing material to effect chemical activity in removing material from the substrate surface. The polishing composition may contain abrasive material to enhance the mechanical activity between the substrate and polishing material. Thus, the CMP apparatus effects polishing or rubbing movement between the surface of the substrate and the polishing material while dispersing a polishing composition to effect both chemical activity and mechanical activity. The chemical and mechanical activity removes excess deposited materials and planarizes the substrate surface.

Conventional polishing material is generally comprised of a foamed polymer, such as polyurethane, having a textured, grooved, or porous surface. The textured or porous surface functions to retain the polishing fluid that normally contains abrasive slurry on the polishing pad during the polishing operation. Conventional polishing materials are generally available in the form of circular pads or in a linear form, such as a web. Generally, the web is periodically advanced over the course of polishing a number of substrates as the effective polishing ability of the surface of the polishing material is eroded during polishing.

Conventional polishing materials generally wear during polishing, causing the surface of the polishing material to lose the ability to adequately retain polishing fluid during the polishing process and result in non-uniform distribution of polishing fluid across the polishing material. Non-uniform distribution of polishing fluid can result in variations of removal rates at portions of the substrate surface and inhibit uniform polishing of a substrate surface. To maintain uniform polishing results, the conventional polishing pads are periodically conditioned by a conditioning disk to return the polishing surface to a polishing condition to again achieve consistent polishing results.

However, conditioning of the polishing material when polishing a series of substrates requires processing time that affects the process throughput and increases operating costs. Additionally, conditioning of the polishing material may result in particulate generation from either the pad or conditioner. The particles may contaminate the polishing pad, which particles can form defects in a substrate surface during polishing of another substrate on the polishing pad. If large numbers of particles are present on the polishing material, defect formation may produce local disparities in polishing rates on the substrate surface that may result in polishing non-uniformities.

Further, conventional polishing pads must be replaced frequently, such as after polishing between about 600 and less than 1000 substrates, which is referred to as the polishing life of the material. Replacing the polishing material is often a time consuming process and increases processing times, processing costs, material costs, and reduces substrate throughput.

Therefore, there is a need for polishing articles, apparatus and methods for polishing substrates with an increased processing life for polishing materials in a substrate processing system.

### SUMMARY OF THE INVENTION

The invention generally provides an article and method for planarizing a substrate surface. In one aspect, the invention provides polishing article including a linear strip of backing material and a plurality of polishing material fibers disposed on the backing material. The polishing material may be impregnated or coated with a polishing enhancing material.

In another aspect, the invention provides polishing article including a linear strip of backing material selected from the group of polyimide, polyester, polyamide, nylon materials, and combinations thereof, and a linear strip of fibrous polishing material selected from the group of polyester, nylon materials, polyamide, and combinations thereof, disposed on the backing material. The linear strip of fibrous polishing material may be a mesh of fibers, a web of fibers, an interwoven cloth of fibers, felt, or combinations thereof. The polishing material may be impregnated or coated with a polishing enhancing material such as polyurethane.

In another aspect, the invention provides a method for processing a substrate including contacting a substrate with a polishing article supported on a platen, wherein the polishing article comprises a linear strip of backing material and a fibrous polishing material disposed on the backing material, and polishing the substrate to remove material therefrom.

### BRIEF DESCRIPTION OF THE DRAWINGS

So that the manner in which the above recited features of the invention are attained and can be understood in detail, a more particular description of the invention, briefly summarized above, may be had by reference to the embodiments thereof which are illustrated in the appended drawings.

It is to be noted, however, that the appended drawings illustrate only typical features of this invention, and are therefore, not to be considered limiting of its scope, for the invention may admit to other equally effective embodiments.

FIG. 1 is a plan view of one embodiment of a chemical mechanical planarization system of the invention;

FIG. 2A is a sectional view of a polishing station taken along section line 3-3 of FIG. 1;

FIG. 2B is a schematic cross section of the polishing head assembly contacting a web of polishing material during polishing;

FIG. 2C is a schematic cross section of the polishing head assembly vertically displaced from the web of polishing material during indexing;

FIG. 2D is a schematic cross section of one embodiment of the web of polishing material described herein; and

FIG. 2E is a schematic cross section of another embodiment of the web of polishing material described herein.

### DETAILED DESCRIPTION OF THE PREFERRED EMBODIMENT

The words and phrases used herein should be given their ordinary and customary meaning in the art by one skilled in the art unless otherwise further defined. Chemical mechanical polishing should be broadly construed and includes, but is not limited to, abrading a substrate surface by chemical activity, mechanical activity, or a combination of both chemical and mechanical activity. Polishing enhancing material is broadly defined herein as any material used in conjunction with a polishing material to increase polishing effects, such as increase polishing removal rates or decrease defect formation, or to improve the physical properties of the polishing material, such as extending polishing life of the material.

In general, aspects of the invention provide methods and apparatus for planarizing a substrate surface with a novel polishing material. The invention will be described below in reference to a polishing material comprising a linear web of material having a linear strip of backing material and a polishing material disposed on the backing material for use in a planarizing process and on an apparatus adapted to planarize a substrate surface. The polishing material may be impregnated, coated, or intermixed, with a polishing enhancing material. Dielectric materials, such as oxides and silicon nitrides, as well as conductive materials, such as metals or polysilicon, disposed on a substrate surface may be removed by a chemical mechanical polishing (CMP) technique with the polishing material described herein.

The invention will be described below in reference to a planarizing process and a polishing article that can be performed on a chemical mechanical polishing system, such as a Reflexion™ CMP System available from Applied Materials, Inc., located in Santa Clara, Calif. Although, the polishing process and composition described herein is illustrated utilizing the Reflexion® CMP System, any system enabling chemical mechanical polishing using the methods or polishing articles described herein can be used to advantage.

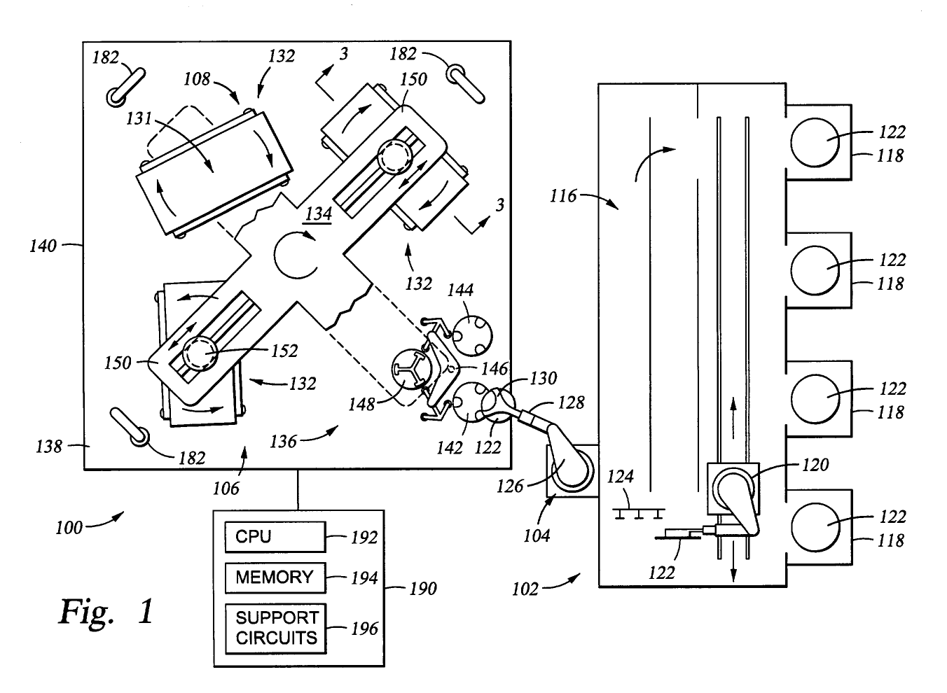

FIG. 1 depicts a plan view of one embodiment of a chemical mechanical planarization system 100 generally having a factory interface 102, a loading robot 104, one or more polishing modules 106, and one or more lift assemblies 108. Generally, the loading robot 104 is disposed proximate the factory interface 102 and the polishing module 106 to facilitate the transfer of substrates 122 therebetween.

A computer based controller 190 is connected to the polishing system or apparatus 120 for instructing the system to perform one or more processing steps on the system, such as polishing a substrate or transferring a substrate in the polishing apparatus 120. In one embodiment, the invention may be implemented as a computer program-product for use with a computer system or computer based controller 190. The programs defining the functions of an embodiment can be provided to a computer via a variety of signal-bearing media and/or computer readable media, which include but are not limited to, (i) information permanently stored on non-writable storage media (e.g., read-only memory devices within a computer such as read only CD-ROM disks readable by a CD-ROM or DVD drive; (ii) alterable information stored on a writable storage media (e.g., floppy disks within diskette drive or hard-disk drive); or (iii) information conveyed to a computer by communications medium, such as through a computer or telephone network, including wireless communication. Such signal-bearing media, when carrying computer-readable instructions that direct the functions of the invention, represent alternative embodiments of the present invention. It may also be noted that portions of the product program may be developed and implemented independently, but when combined together are embodiments of the present invention.

The factory interface 102 generally includes a cleaning module 116 and one or more substrate cassettes 118. An interface robot 120 is employed to transfer substrates 122 between the substrate cassettes 118, the cleaning module 116 and an input module 124. The input module 124 is positioned to facilitate transfer of substrates 122 between the polishing module 106 and the factory interface 102 by the loading robot 104. For example, unpolished substrates 122 retrieved from the cassettes 118 by the interface robot 120 may be transferred to the input module 124 where the substrates 122 may be accessed by the loading robot 104 while polished substrates 122 returning from the polishing module 106 may be placed in the input module 124 by the loading robot 104. Polished substrates 122 are typically passed from the input module 124 through the cleaning module 116 before the factory interface robot 120 returns the cleaned substrates 122 to the cassettes 118. An example of such a factory interface 102 that may be used to advantage is disclosed in U.S. Pat. No. 6,361,422, issued Mar. 26, 2002, which is hereby incorporated by reference.

The loading robot 104 is generally positioned proximate the factory interface 102 and the polishing module 106 such that the range of motion provided by the robot 104 facilitates transfer of the substrates 122 therebetween. An example of a loading robot 104 is a 4-Link robot, manufactured by Kensington Laboratories, Inc., located in Richmond, Calif.

The exemplary loading robot 104 has an articulated arm 126 having a rotary actuator 128 at its distal end. An edge contact gripper 130 is coupled to the rotary actuator 128. The rotary actuator 128 permits the substrate 122 secured by the gripper 130 to be oriented in either a vertical or a horizontal orientation without contacting the feature side 120 of the substrate 122 and possibly causing scratching or damage to the exposed features. Additionally, the edge contact gripper 130 securely holds the substrate 122 during transfer, thus decreasing the probability that the substrate 122 will become disengaged. Optionally, other types of grippers, such as electrostatic grippers, vacuum grippers and mechanical clamps, may be substituted.

Polishing modules 106 including those that use polishing article, polishing webs, or a combination thereof may also be used to advantage. Other systems that benefit include systems that move a substrate relative a polishing surface in a rotational, linearly or in other motion within a plane.

The exemplary polishing module 106 has a transfer station 136, a plurality of polishing stations 132 and a carousel 134 disposed on an upper or first side 138 of a machine base 140. In one embodiment, the transfer station 136 comprises at least an input buffer station 142, an output buffer station 144, a transfer robot 146, and a load cup assembly 148. The loading robot 104 places the substrate 122 onto the input buffer station 142. The transfer robot 146 has two gripper assemblies, each having pneumatic gripper fingers that grab the substrate 122 by the substrate's edge. The transfer robot 146 lifts the substrate 122 from the input buffer station 142 and rotates the gripper and substrate 122 to position the substrate 122 over the load cup assembly 148, then places the substrate 122 down onto the load cup assembly 148. An example of a transfer station that may be used to advantage is described by Tobin in U.S. Pat. No. 6,156,124, issued Dec. 5, 2000, which is hereby incorporated by reference.

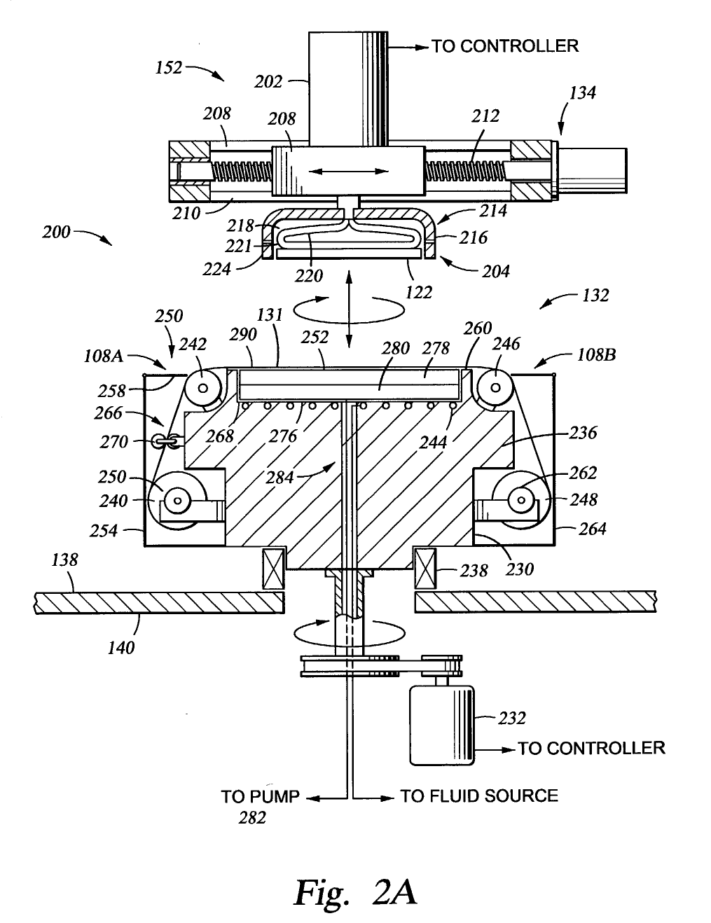

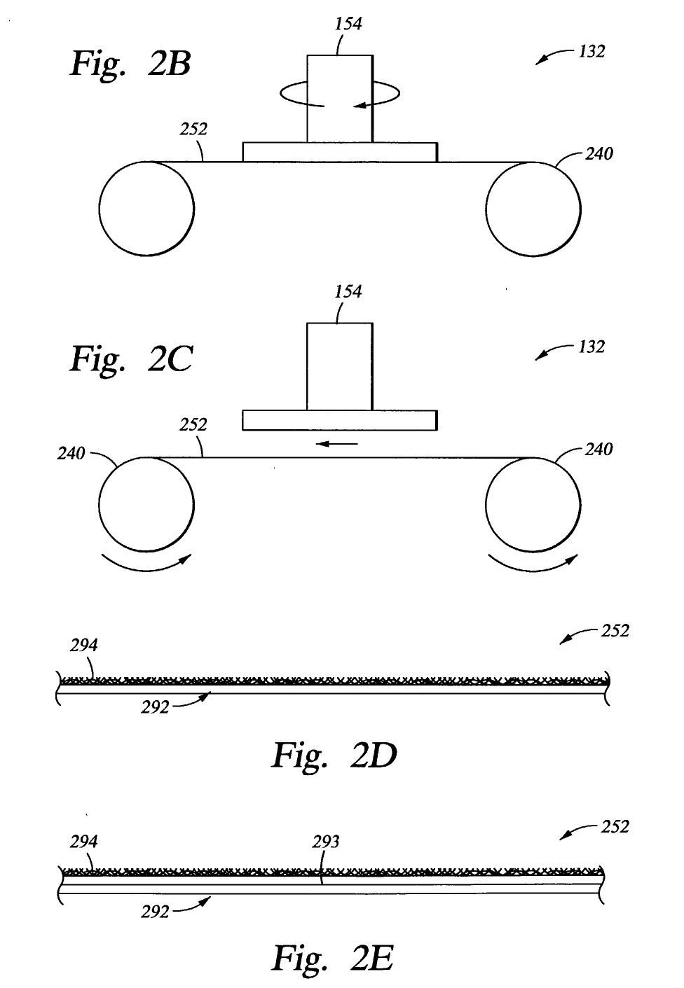

The carousel 134 is generally described by Tolles in the previously incorporated U.S. Pat. No. 5,804,507. Generally, the carousel 134 is centrally disposed on the base 140. The carousel 134 typically includes a plurality of arms 150, each supporting a polishing head assembly 152. Two of the arms 150 depicted in FIG. 2 are shown in phantom such that a polishing surface 131 of one of the polishing stations 132 and the transfer station 136 may be seen. The carousel 134 is indexable such that the polishing head assemblies 152 may be moved between the polishing stations 132 and the transfer station 136.

Generally, a chemical mechanical polishing process is performed at each polishing station 132. A conditioning device 182 is disposed on the base 140 adjacent each polishing station 132. The conditioning device 182 periodically conditions the polishing surface 131 to maintain uniform polishing results.

A computer based controller 190 is connected to the polishing system or apparatus 120 for instructing the system to perform one or more processing steps on the system, such as polishing a substrate or transferring a substrate in the polishing apparatus 120.

Although the process described herein is discussed as being implemented by a software routine, some or all of the method steps may be performed in hardware as well as by the software controller. As such, the invention may be implemented in software as executed upon a computer system, in hardware as an application specific integrated circuit or other type of hardware implementation, or a combination of software and hardware.

FIG. 2A depicts a sectional view of the polishing head assembly 152 supported above the polishing station 132. The polishing head assembly 152 generally comprises a drive system 202 coupled to a polishing head 204. The drive system 202 generally provides rotational motion to the polishing head 204. The polishing head 204 additionally may be actuated to extend towards the polishing station 132 such that the substrate 122 retained in the polishing head 204 may be disposed on the polishing station 132 as shown in FIG. 2B.

The drive system 202 is coupled to a carrier 208 that translates upon a rail 210 disposed in the arm 150 of the carousel 134. A ball screw or other linear motion device 212 couples the carrier 208 to the carousel 134 and positions the drive system 202 and polishing head 204 along the rail 210.

In one embodiment, the polishing head 204 is a TITAN HEAD™ substrate carrier manufactured by Applied Materials, Inc., Santa Clara, Calif. Generally, the polishing head 204 comprises a housing 214 having an extending lip 216 that defines a center recess 218 in which is disposed a bladder 220. The bladder 220 may be comprised of an elastomeric material or thermoplastic elastomer such as ethylene propylene, silicone and HYTREL™ polymer. The bladder 220 is coupled to a fluid source (not shown) such that the bladder 220 may be controllably inflated or deflated. The bladder 220, when in contact with the substrate 122, retains the substrate 122 within the polishing head 204 by deflating, thus creating a vacuum between the substrate 122 and the bladder 220. A retaining ring 224 circumscribes the polishing head 204 to retain the substrate 122 within the polishing head 204 while polishing.

Disposed between the polishing head assembly 154 and the polishing station 132 is polishing article, such as a web of polishing material 252. The web of polishing material 252 may have a smooth surface, a textured surface, or a combination of smooth and textured surfaces. For example, the web of polishing material may have a textured portion such as a center portion of the web or have a textured perimeter portion, while the remaining surface of the web is smooth.

The polishing station 132 generally comprises a platen 230 that is disposed on the base 140. The platen 230 is typically comprised of aluminum. The platen 230 is supported above the base 140 by a bearing 238 so that the platen 230 may rotate in relation to the base 140. An area of the base 140 circumscribed by the bearing 238 is open and provides a conduit for the electrical, mechanical, pneumatic, control signals and connections communicating with the platen 230.

Conventional bearings, rotary unions and slip rings (not shown) are provided such that electrical, mechanical, pneumatic, control signals and connections may be coupled between the base 140 and the rotating platen 230. The platen 230 is typically coupled to a motor 232 that provides the rotational motion to the platen 230.

The platen 230 has an upper portion 236 that supports the web of polishing material 252. A top surface 260 of the platen 230 contains a center recess 276 extending into the top portion 236. The top portion 236 may optionally include a plurality of passages 244 disposed adjacent to the recess 276. The passages 244 are coupled to a fluid source (not shown). Fluid flowing through the passages 244 may be used to control the temperature of the platen 230 and the polishing material 252 disposed thereon. The web of polishing material 252 may be in the form of a pad, roll or sheet of material that may be advanced across or releasably fixed to the polishing surface. Typically, the web of polishing material 252 is releasably fixed by adhesives, vacuum, mechanical clamps or by other holding methods to the platen 230.

A sub-pad 278 and a sub-plate 280 are disposed in the center recess 276. The sub-pad 278 is typically a polymeric material, such as polycarbonate or foamed polyurethane. Generally, the hardness or durometer of the sub-pad may be chosen to produce a particular polishing result. The sub-pad 278 generally maintains the polishing material 252 parallel to the plane of the substrate 122 held in the polishing head 204 and promotes global planarization of the substrate 122. The sub-plate 280 is positioned between the sub-pad 278 and the bottom of the recess 276 such that the upper surface of the sub-pad 278 is coplanar with the top surface 260 of the platen 230.

Both the sub-pad 278 and the sub-plate 280 optionally contain a plurality of apertures (not shown) that are generally disposed in a pattern such that the polishing motion of the substrate 122 does not cause a discrete portion of the substrate 122 to pass repeatedly over the apertures while polishing as compared to the other portions of the substrate 122. A vacuum port 284 is provided in the recess 276 and is coupled to an external pump 282. When a vacuum is drawn through the vacuum port 284, the air removed between the polishing material 252 and the sub-pad 278 causes the polishing material 252 to be firmly secured to the sub-pad 278 during polishing.

An example of such polishing material retention system is disclosed in U.S. patent application Ser. No. 09/258,036, filed Feb. 25, 1999, by Sommer et al., which is hereby incorporated by reference. The reader should note that other types of devices might be utilized to fix the polishing material 252 to the platen 230, for example, adhesives, bonding, electrostatic chucks, mechanical clamps and other retention mechanisms.

Optionally, to assist in releasing the polishing material 252 from the sub-pad 278 and platen 230 prior to advancing the polishing material 252, surface tension caused by fluid that may be disposed between the sub-pad 278 and the polishing material 252, a blast of gas (e.g., air) may be provided through the vacuum port 284 or other port (not shown) into the recess 276 by the pump 282 (or other pump). The air pressure within the recess 276 moves through the apertures (not shown) disposed in the sub-pad 278 and sub-plate 280 and lifts the polishing material 252 from the sub-pad 278 and the top surface 260 of the platen 230. The polishing material 252 rides upon the cushion of air such that it may be freely indexed across the platen 230.

Alternatively, the sub-pad 278 may be a porous material that permits gas (e.g., air) to permeate therethrough and lift the polishing material 252 from the platen 230. Such a method for releasing the web 252 is described in U.S. patent application Ser. No. 09/676,395, filed Sep. 29, 2000, by Butterfield, et al., and is hereby incorporated by reference in its entirety.

Mounted to one side of the platen 230 is a supply roll 240. The supply roll 240 generally contains a portion of the web of polishing material 252 wound thereon. The web of polishing material 252 is fed over a lift member 242 of the lift assembly 108A and across the top surface 260 of the platen. The web of polishing material 252 is fed over a lift member 246 of the lift assembly 108B and to a take-up roll 248 disposed to the other side of the platen 230. The lift members 242, 246 may be a roller, a rod, a bar or other member configured to allow the web 252 to move thereover with minimal damage to the web, particulate generation or contamination of the web.

The supply roll 240 is removably coupled to the platen 230 to facilitate loading another unwind roll containing unused polishing article once the web of polishing material 252 is consumed over the course of polishing a number of substrates. The supply roll 240 is coupled to a slip clutch 250 or similar device that prevents the web of polishing material 252 from inadvertently unwinding from the supply roll 240.

A housing 254 that protects the supply roll 240 from damage and contamination covers the supply roll 240. To further prevent contamination of the supply roll 240, a gas is disposed in the volume between the housing 254 and the platen 230 which flows out a gap 256 defined between an edge 258 of the housing 254 and the web of polishing material 252 disposed on the lift member 242. The gas flowing through the gap 256 prevents contaminants such as polishing fluids and byproducts from coming in contact with the unused portion of the web of polishing material 252 disposed on the supply roll 240 enclosed by the housing 254.

The take-up roll 248 generally is removably coupled to the platen 230 to facilitate removal of used polishing article that is wound thereon. The take-up roll 248 is coupled to a tensioning device 262 that keeps the web of polishing material 252 taunt between the supply roll 240 and take-up roll 248. A housing 264 disposed over the take-up roll 248 protects the take-up roll 248 from damage and contamination.

The web of polishing material 252 is advanced between the supply roll 240 and take-up roll 248 by an indexing means 266. In one embodiment, the indexing means 266 comprises a drive roller 268 and an idler 270 that pinches the web of polishing material 252 therebetween. The drive roller 256 generally is coupled to the platen 230. The drive roller 256 is connected to a controlled motor such as a stepper and an encoder (motor and encoder not shown). The indexing means 266 enables a predetermined length of polishing material to be pulled off the supply roll 240 by drive roller 256 as the drive roller 256 is controllably rotated. The predetermined length is usually about 1 inch or less, such as about ¼ inch indexing between substrates. A corresponding length of polishing material is wound on the take-up roll 248 as the web of polishing material 252 is advanced across the platen 230. The roll of polishing material 252 is about 100 feet in length, which allows for about 5000 or more substrates to be polished as compared to prior art polishing pads which often have to be replaced after 600 to 1000 substrates are polished.

Referring to FIG. 2C, before the web of polishing material 252 is advanced across the platen 230, at least one of the lift assemblies 108A or 108B is raised to an extended position to maintain the web of polishing material 252 in a spaced-apart relation to the platen 230. In a spaced-apart relation, the web 252 may be freely advanced without having to overcome surface tension due to fluid disposed between the web and the platen or possibly creating particulate by contacting the backside of the web with the platen while the web is moving.

To facilitate control of the system as described above, the controller 190 may include a CPU 192 of FIG. 1, which CPU 192 may be one of any form of computer processors that can be used in an industrial setting for controlling various chambers and subprocessors. The memory 194 is coupled to the CPU 192. The memory 194, or computer-readable medium, may be one or more of readily available memory, such as random access memory (RAM), read only memory (ROM), floppy disk, hard disk, or any other form of digital storage, local or remote. For storing information and instructions to be executed by the CPU 192.

The support circuits 196 are coupled to the CPU 192 for supporting the processor in a conventional manner. These circuits include cache, power supplies, clock circuits, input/output circuitry and subsystems, and can include input devices used with the controller 190, such as keyboards, trackballs, a mouse, and display devices, such as computer monitors, printers, and plotters. Such controllers 190 are commonly known as personal computers; however, the present invention is not limited to personal computers and can be implemented on workstations, minicomputers, mainframes, and supercomputers.

A process, such as the polishing processes described below, is generally stored in the memory 194, typically as a software routine. The software routine may also be stored and/or executed by a second CPU (not shown) that is remotely located from the hardware being controlled by the CPU 192.

Referring to FIGS. 1 and 2D-E, the polishing article in the form of a web of polishing material 252 will now be described. The web of polishing material 252 generally includes a linear web of material having a linear strip of backing material 292 and a polishing material 294 disposed on the backing material 292 as shown in FIG. 2D. The web of polishing material 252 may be porous or non-porous. A layer of adhesive material 293 may be disposed between the polishing material 294 and the backing material 292 to affix the materials together as shown in FIG. 2E. FIGS. 2D and 2E are not drawn to scale, but to illustrate the interrelation of the materials.

The linear strip of backing material 292 provides support for the polishing material 294. The backing material 292 comprises a polymeric material including polyimide, polyester, polyamide, nylon materials, or combinations thereof. The linear strip of backing material 292 may be porous or non-porous. The linear strip may be adapted to be secured to a platen surface by the application of vacuum, and the porous nature of the backing material 292 may be adapted to achieve this vacuum aspect.

The polishing material 294 disposed on the backing material 292 provides a polishing surface to contact a substrate surface (not shown). The polishing material 294 may be individual fibers randomly disposed or individual fibers disposed in a desired pattern or orientation on the linear strip of backing material 292. Additionally, the fibers may be use to form a mesh or web of interconnected fibers, an interwoven cloth of fibers, or combinations thereof. The fibers may also form a felt material, which is a fabric of matted, compressed fibers. The polishing material 294 generally includes between about 10 weight percent (wt. %) and about 60 wt. % of the web of polishing material 252.

The fibers generally include a polymeric fiber material, such as polyester fibers, polyamide fibers, nylon fibers, and combination thereof. The fiber length is in the range between about 1 μm and about 1000 μm with a diameter between about 0.1 μm and about 20 μm. In one aspect, the diameter of the fibers may be between about 5 μm to about 200 μm with an aspect ratio of length to diameter of about 5 or greater, such as about 10 or greater. The cross-sectional area of the fibers may be circular, elliptical, star-patterned, “snow flaked”, or of any other shape of manufactured dielectric or conductive fibers.

An adhesive material 293 may be used to affix the polishing material 294 to the linear strip of backing material 292. The adhesive material 293 generally comprises an epoxy adhesive, a polymer based adhesive, or any adhesive suitable for use with the web materials described herein. Further examples of adhesive materials are bonding agents including a silicone, an urethane resin, a polyimide, a polyamide, a fluoropolymer, fluorinated derivatives thereof, or combinations thereof.

The polishing material 294 may be impregnated, coated, or intermixed with a polishing enhancing material. The polishing enhancing material may be added to improve polishing removal rates, to improve polishing quality, for example, reducing defect formation, such as scratches, or to enhance physical properties of the polishing material, such as hardness or increase pad life. The polishing enhancing material may include between about 10 volume percent (vol %) and 60 vol % of the polishing material 294. For example the polishing material 294 may comprise between about 50 vol % of fibers and 50 vol % of polishing enhancing material.

Polishing enhancing materials include polymeric materials, such as polyurethane, polycarbonate, tetrafluoroethylene fluorocarbon polymers, fluorinated ethylene-propylene resins, copolymers of tetrafluoroethylene fluorocarbon polymers and fluorinated ethylene-propylene resin, or combinations thereof. Polishing enhancing material may also include binding materials, such as urethanes. For example, the felt material described above may include fibers leeched in, or impregnated with, urethane. An example of a polishing enhancing material is Teflon®, a trademark of tetrafluoroethyl (TEF) fluorocarbon polymers produced by E. I. Du Pont de Nemours and Company, of Wilmington, Del.

The invention contemplates that any suitable polishing material used in polishing substrate surfaces, such as conventional polishing material, may be used herein as the polishing enhancing material. Conventional polishing materials are generally dielectric materials and may include polymeric materials, for example dielectric polymeric materials. Examples of dielectric polymeric polishing materials include polyurethane and polyurethane mixed with fillers, polycarbonate, polyphenylene sulfide (PPS), polystyrene, ethylene-propylene-diene-methylene (EPDM), or combinations thereof, and other polishing materials used in polishing substrate surfaces.

An example of the web of polishing material 252 is a polyester backing material and nylon fibers disposed on the polyester material, wherein the nylon fibers are impregnated with polyurethane at about 50 wt. % of the Nylon™ fibers and about 50 wt. % of polyurethane, and the nylon fibers are adhered to the polyester backing material by an adhesive.

The web of polishing material 252 generally has a thickness of about 100 mils or less, such as between about 10 mils and about 30 mils. An example of the thickness of the web of polishing material 252 is between about 24 and about 29 mils. The linear strip of backing material 292 may have a thickness of about 50 mils or less, for example, between about 5 and about 10 mils. The polishing material 294 may have a thickness of about 50 mils or less, such as between about 5 and about 30 mils.

The web of polishing material 252 is adapted to provide for flow of polishing fluid therethrough. In one example, pores or perforations may be formed in the web of polishing material 252 either by inherent pore formation in creating the polishing materials or by mechanical methods after formation. For example, perforations may be formed in the webs of polishing material that contain an adhesive material, such as adhesive layer 293 described herein, which may detrimentally affect fluid flow therethrough.

Pores or perforations include apertures, holes, openings, or passages formed partially or completely through one or more layers of the web of polishing material 252. The perforation size and density is selected to provide uniform distribution of the polishing composition through the web of polishing material 252. The web of polishing material 252 may have a porosity, also called a perforation density, between about 20% and about 80% of the polishing article. A porosity of about 50% has been observed to provide sufficient composition flow with minimal detrimental effects to polishing processes. Perforation density is broadly described herein as the area or volume of polishing article that the perforations comprise, i.e., the aggregate number and diameter or size of the perforations, of the surface or body of the polishing article when perforations are formed in the polishing article.

The web of polishing material 252 may have a textured surface to improve polishing removal rate. The web of polishing material 252 may have a compressibility of between about 10% and about 30%, for an applied contact pressure between a substrate and the web of polishing material 252 up to about 8 psi. For example, the web of polishing material 252 may have a compressibility of between about 12% and about 22% under an applied pressure of between about 4 psi and about 5 psi. The compressibility is described as the amount of deformation or compression of the web of polishing material 252 when a pressure is applied divided by the thickness of the web of polishing material 252 absent the application of pressure.

The web of polishing material 252 may have a density of between about 0.3 g/cm³ and about 36 g/cm³. The web of polishing material 252 may have a hardness of about 90 or less, such as between about 65 and about 85 on the Shore A Hardness scale for polymeric materials as described and measured by the American Society for Testing and Materials (ASTM), headquartered in Philadelphia, Pa.

The web of polishing material 252 has been observed to support a removal rate of copper materials of about 2500 Å/min or greater, such as about 5000 Å/min at process requirements of pressures and rotational speeds, for example, at about 0.5 psi at 200 rpms, for greater than 1000 substrates, for example, greater than about 5000 substrates, prior to replacement.

It is believed that the extended wear of the web of polishing material over conventional materials is due to the linear format of the web of polishing material. The polishing materials and the backing materials used allow for the formation of thin, linear web of the polishing material that can provide sufficient removal rates for materials while providing necessary flexibility to be used in a roll to roll configuration on a polishing apparatus. Further, the linear format of the web in a roll to roll configuration can allow for indexing the polishing material as the polishing material is eroded during polishing to provide new polishing material during polishing. Traditional round polishing pads, such as the IC-1010 polishing pad and materials available from Rodel Inc., of Phoenix, Ariz., are structured as hard and inflexible polishing pads, and therefore, cannot be formed into webs of material, indexed between substrate polishing as necessary, or applied to a polishing apparatus in a roll format. As such, traditional polishing pads must be replaced more often, i.e., every 2000 substrates, even if conditioned to extend usable polishing life.

While the web of polishing material 252 is shown herein as a linear strip of material, the polishing material 252 may alternatively be in the form of a roll or sheet of material that may be advanced across and releasably fixed to the polishing surface. Typically, the web of polishing material 252 is releasably fixed to the platen 230 by adhesives, vacuum, mechanical clamps or by other holding methods.

In an example of the operation of the chemical mechanical planarization system 100, a substrate is disposed face down in a polishing head 204 disposed in the carrier 208 and positioned over a polishing platen 230 supporting a web of polishing material 252 described herein. The substrate may comprise a conductive material, such as a copper-containing material, deposited on the surface of a substrate and in feature definitions formed in a low k dielectric material. A barrier layer material may be deposited in the feature definitions prior to depositing the copper material. The substrate may be formed by etching feature definitions in a dielectric layer, depositing a barrier layer material on the substrate surface and in the feature definitions, and depositing a copper-containing material over the substrate surface to fill the feature definitions.

As used throughout this disclosure, the phrase “copper-containing material”, “copper” and the symbol Cu are intended to encompass high purity elemental copper as well as doped copper and copper-based alloys, e.g., doped copper and copper-based alloys containing at least about 80 wt. % copper. The barrier layer material includes tantalum, tantalum nitride, and derivatives thereof, such as tantalum silicon nitride. The invention described herein also contemplates the use of other barrier materials known or unknown that may be used as a barrier with conductive materials, such as copper.

The dielectric layer can comprise any of various dielectric materials known or unknown that may be employed in the manufacture of semiconductor devices. For example, dielectric materials, such as silicon dioxide, phosphorus-doped silicon glass (PSG), boron-phosphorus-doped silicon glass (BPSG), and carbon-doped silicon dioxide, can be employed. The dielectric layer can also comprise low dielectric constant materials, including fluoro-silicon glass (FSG), polymers, such as polymides, and carbon-containing silicon oxides, such as Black Diamond™ dielectric material, available from Applied Materials, Inc. of Santa Clara, Calif. Low dielectric constant materials (low k) are generally defined as dielectric material having a dielectric constant (k) of about 4 or less. The openings are formed in interlayer dielectrics by conventional photolithographic and etching techniques. The invention also contemplates the use of dielectric materials, known or unknown, that may be used as dielectric layers in semiconductor fabrication.

The substrate and the polishing surface of the web of polishing material 252 are contacted at a polishing pressure between about 0.5 psi and about 8 psi. For polishing metal disposed in low k dielectric materials, a polishing pressure of less than about 2 psi, such as between about 0.5 psi and about 1.5 psi may be used.

The platen 230 is rotated at a rotational speed between about 10 rpms and about 800 rpms, such as between about 10 rpms and about 200 rpms, and the carrier head is rotated at a rotational speed between about 10 rpms and about 800 rpms, such as between about 10 and about 200 rpms.

An appropriate polishing composition is applied to polish the conductive materials, such as copper, or tungsten among others. For example, EPC-5001, EPC-5003, or EPC-5306, commercially available from Cabot Corp. of Aurora, Ill., are compositions that may be used to polish copper-containing materials. Using the web of polishing material 252 under the processing conditions described herein, conductive material may be removed at rates up to about 8000 Å/min, for example, up to about 5000 Å/min.

The web of polishing material described herein has been observed to have comparable if not higher polishing rates than existing commercial polishing materials. For example, a comparison of IC-1010 polishing materials available from Rodel Inc., of Phoenix, Ariz., with a web of polishing material having a polyester backing material and nylon fibers disposed on the polyester material was performed. Another web of polishing material having polyurethane as a polishing enhancing material was also compared. The data from the polishing results indicated the web of polishing material with and without polyurethane exhibited increased removal rates at lower pressure, i.e., about 0.5 psi, and lower platen speeds, i.e., less than about 300 rpm for the web with polyurethane and less than about 800 rpms for the web without polyurethane, than the IC-1010 polishing pad.

For example, the web of polishing material had a removal rate of about 3500 Å/min compared to the IC-1010 polishing pad's removal rate of about 2000 Å/min at processing conditions of a pressure of about 0.5 psi and a platen rotational speed of about 100 rpms. The web of polishing material 252 described herein was also observed to have improved planarization over the IC-1010 pad materials.

Following polishing, the web of polishing material 252 may be advanced prior to polishing another substrate. In the above example, the web of polishing material was indexed as described herein between about ¼″ and about ½″ between each wafer. Additionally, the web of polishing material 252 may be conditioned before or after polishing the substrate by a conditioning apparatus, such as a conditioning disk. The web of polishing material 252 may be indexed and conditioned to provide effective polishing of about 5000 or more substrate according to the polishing process described herein.

While the foregoing is directed to embodiments of the present invention, other and further embodiments of the invention may be devised without departing from the basic scope thereof, and the scope thereof is determined by the claims that follow.

What is claimed is:

1. A polishing article comprising a linear strip of backing material and a plurality of polishing material fibers disposed on the backing material.

2. The polishing article of claim 1; wherein the linear strip of backing material comprises a polymeric material selected from the group of polyimide, polyester, polyamide, nylon materials, and combinations thereof, and the polishing material comprises a polymeric material selected from the group of polyester, nylon materials, polyamide, and combinations thereof.

3. The polishing article of claim 1, wherein the polishing material fibers comprises between about 10 wt. % and about 60 wt. % of the polishing article.

4. The polishing article of claim 1, wherein the polishing material fibers further comprise a polishing enhancing material selected from the group of polyurethane, polycarbonate, tetrafluoroethylene fluorocarbon polymers, fluorinated ethylenepropylene resins, copolymers of tetrafluoroethylene fluorocarbon polymers and fluorinated ethylene-propylene resin, and combinations thereof.

5. The polishing article of claim 4, wherein the polishing enhancing material comprises between about 10 wt. % and about 60 wt. % of the polishing material.

6. The polishing article of claim 1, wherein the polishing material fibers have a random orientation and are fixed to the linear strip of backing material by an adhesive.

7. The polishing article of claim 1, wherein the polishing article comprises a porous material having a thickness between about 5 and about 30 mils.

8. The polishing article of claim 1, wherein the polishing article has a compressibility of between about 10% and 30% under a pressure of up to about 5 psi.

9. The polishing article of claim 1, wherein the polishing article comprises a polyester backing material and nylon fibers disposed on the polyester material, wherein the nylon fibers are impregnated with urethane, polyurethane, or combinations thereof, at about 50 wt. % of the nylon fibers, and wherein the nylon fibers are adhered to the polyester backing material by an adhesive.

10. A polishing article comprising:
a linear strip of backing material selected from the group of polyimide, polyester, polyamide, nylon materials, and combinations thereof; and
a linear strip of fibrous polishing material selected from the group of polyester, nylon materials, polyamide, and combinations thereof, disposed on the backing material, wherein the linear strip of fibrous polishing material comprises a mesh of fibers, a web of fibers, an interwoven cloth of fibers, felt, or combinations thereof.

11. The polishing article of claim 10, wherein the linear strip of polishing material is fixed to the linear strip of backing material by an adhesive.

12. The polishing article of claim 10, wherein the polishing material further comprises a polishing enhancing material selected from the group of polyurethane, polycarbonate, tetrafluoroethylene fluorocarbon polymers, fluorinated ethylenepropylene resins, copolymers of tetrafluoroethylene fluorocarbon polymers and fluorinated ethylene-propylene resin, and combinations thereof.

13. The polishing article of claim 10, wherein the polishing enhancing material comprises between about 10 wt. % and about 60 wt. % of the polishing material.

14. The polishing article of claim 10, wherein the polishing article comprises a porous material having a thickness between about 5 and about 30 mils, wherein the a linear strip of backing material has a thickness between about 5 mils and about 10 mils and the linear strip of polishing material has a thickness between about 5 mils and about 25 mils.

15. The polishing article of claim 10, wherein the polishing article comprises a porous material having a compressibility of between about 10% and 30% under a pressure of up to about 5 psi.

16. The polishing article of claim 10, wherein the polishing article comprises a polyester backing material and a cloth of interwoven nylon fibers, polyester fibers, or combinations thereof, disposed on the polyester material, wherein the cloth is impregnated with a polishing polyurethane at about 50 wt. % of the nylon and polyester fibers, and wherein the nylon fibers are adhered to the polyester backing material by the adhesive.

17. A method for processing a substrate, comprising:
contacting a substrate with a polishing article supported on a platen, wherein the polishing article comprises a fibrous polishing material disposed on a backing material; and
polishing the substrate to remove material therefrom.

18. The method of claim 17, wherein the substrate and the polishing article are contacted at a pressure of about 8 psi or less.

19. The method of claim 17, wherein the linear platen is further rotated between about 10 rpms and about 200 rpms during polishing.

20. The method of claim 17, further comprising indexing the polishing article prior to polishing the substrate, subsequent to polishing the substrate, or combinations thereof.

21. The method of claim 17, wherein indexing the polishing article comprises advancing the polishing article by about 1 inch or less.

22. The method of claim 17, further comprising conditioning the polishing article before or after polishing the substrate.

23. The method of claim 17, further comprising applying a vacuum to the polishing article during polishing.

24. The method of claim 17, wherein the backing material comprises a polymer selected from the group of polyimide, polyester, polyamide, nylon materials, or combinations thereof and the polishing material comprises a polymeric material selected from the group of polyester, nylon materials, polyamide, and combinations thereof.

25. The method of claim 24, wherein the fibrous polishing material further comprises a polishing enhancing material selected from the group of polyurethane, polycarbonate, tetrafluoroethylene fluorocarbon polymers, fluorinated ethylenepropylene resins, copolymers of tetrafluoroethylene fluorocarbon polymers and fluorinated ethylene-propylene resin, and combinations thereof.

26. The polishing article of claim 17 wherein the polishing material is affixed to the linear strip of backing material by an adhesive.

27. The method of claim 17, wherein the fibrous polishing material is in the form of individual fibers, a mesh of fibers, a web of fibers, an interwoven cloth of fibers, felt, or combinations thereof.
